(19) United States
(12) Patent Application Publication
(10) Pub. No.: US 2015/0242418 A1
(43) Pub. Date: Aug. 27, 2015

(54) DEVICE-BASED IDENTIFICATION

(71) Applicant: International Business Machines Corporation, Armonk, NY (US)

(72) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John E. Moore, Jr., Brownsburg, IN (US)

(73) Assignee: International Business Machines Corporation, Armonk, NY (US)

(21) Appl. No.: 14/192,147

(22) Filed: Feb. 27, 2014

(51) Int. Cl. G06F 17/30

(52) U.S. Cl. CPC G06F 17/3087; G06F 17/30598

(57) ABSTRACT

A system and method to determine an identity of an individual carrying one or more devices configured to communicate with the system is described. The system includes an input interface to receive information from one or more of the one or more devices, and a database storing data related to the individual in correspondence with the information. The system also includes a processor to determine the identity of the individual based on the information when the information provides the identity directly and to determine the identity of the individual based on the data in the database when the information relates to the respective one or more of the one or more devices. The system may be within or outside of a second device of a second individual.

### BACKGROUND

The present invention relates to identification, and more specifically, to identification of a person based on one or more devices.

Recognition and identification of a person is a basic part of interactions among individuals. When a person announces their identity or is recognized, this interaction is readily established. However, there may be circumstances when a person is recognized but not identified. For example, a person may appear familiar but their name may have been forgotten. This may lead to an awkward interaction. In other circumstances, a known person may be nearby but not identified. For example, two people who had been interacting over the phone or online may be near each other without realizing it.

### SUMMARY

According to one embodiment of the present invention, a system to determine an identity of an individual carrying one or more devices configured to communicate with the system includes an input interface configured to receive information from one or more of the one or more devices; a database storing data related to the individual in correspondence with the information; and a processor configured to determine the identity of the individual based on the information when the information provides the identity directly and to determine the identity of the individual based on the data in the database when the information relates to the respective one or more of the one or more devices.

According to another embodiment of the invention, a method of determining an identity of an individual carrying one or more devices configured to communicate with an identification system includes receiving, at an input interface of the identification system, information from one or more of the one or more devices; storing, at a database, data related to the individual in correspondence with the information; and processing, by a processor of the identification system, the information to identify the individual based directly on the information when the information provides the identity and based on the data from the database when the information relates to the respective one or more of the one or more devices.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a system for device-based identification according to an embodiment;

FIG. 2 illustrates an exemplary scenario with two users of devices in communication with the system according to embodiments of the invention; and

FIG. 3 is a process flow of a method of device-based identification according to embodiments of the invention.

### DETAILED DESCRIPTION

As noted above, there may be various circumstances in which desired interactions are missed because the identity of a person is forgotten or unknown. Embodiments of the method and system described herein relate to identifying a person based on one or more devices carried by that person.

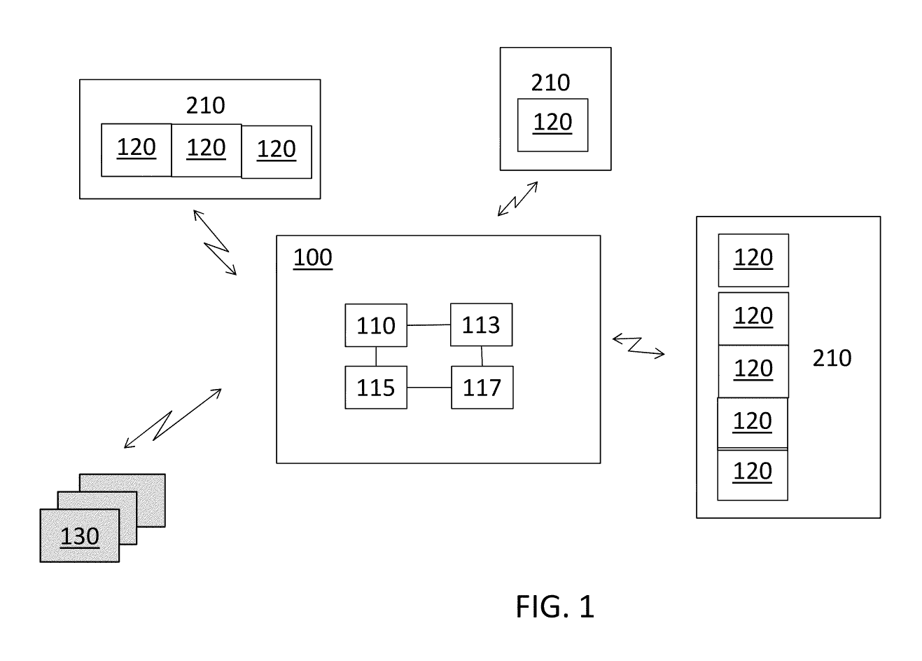

FIG. 1 is a block diagram of a system 100 for device-based identification according to an embodiment. The system 100 interacts with devices 120 belonging to a user 210. The devices 120 that the system 100 interacts with may be within a specified distance, within a specified enterprise (e.g., all the devices associated with a specified corporation or in an office building), or associated with a specified service provider, for example. The one or more parameters (e.g., proximity, user selection) determining which devices 120 are in contact with the system 100 may be determined in any number of ways. The system 100 also interacts with one or more databases 130. The databases 130 may be associated with a corporation or a service provider, for example. For example, the system 100 may have access to calendar applications of all employees of a corporation as one exemplary database 130. The system 100 collects information about the devices 120 and may provide identification information to one or more devices 120 based, for example, on a request or setting.

The system 100 includes one or more processors 110, one or more memory devices 113, an input interface 115, and an output interface 119. The system 100 communicates with the devices 120 using the input interface 115 and the output interface 119. Some of the devices 120 may broadcast information to the system 100 while other devices 120 must be polled by the system 100. Still other devices 120 may not communicate with the system 100 at all for various reasons (e.g., they are turned off, the device 120 user has selected an option to prevent communication). Through the communication with the devices 120, the system 100 obtains information. The information may itself provide an identity of the user 210 of the device 120. In other cases, the information may be used by the system 100 in conjunction with other information from one or more databases 130 to determine an identity of the user 210 of the device 120. The system 100 may store an association between a device 120 and the identity of the user 210 of the device in the memory device 113. In some embodiments, the identity may be a direct identifier of the user 210 (e.g., name, employee identification number). In other embodiments, the identity of the user 210 may indicate that the user 210 is or is not part of a predefined group (e.g., employee, person with clearance, authorized ticket holder at a venue). In some embodiments, the device 120 may broadcast the identity of the device user 210 to the system 100. According to other embodiments, the device 120 may provide information about the device (e.g., a type of the device, a phone number, a Wi-Fi identity (ID)) that may be used by the system 100 to determine an identity of the user 210. When the information does not provide a direct identity of the device user, the system 100 may communicate with one or more external databases 130 to determine the device user 210 identity as detailed below. The memory device 113 additionally stores a distance to each device 120 in communication with the system 100. The position of a device 120 or distance between devices 120 may be determined based on triangulation, radio signal strength, global positioning system (GPS) data, or another known technique. The distance to another device 120 may be among the information (in addition to identify of the device 120 user, for example) provided by the system 100. Once the user 210 identity and distances of corresponding devices 120 are determined, they may be stored in the memory device 113 of the system 100 to provide to other users 210 as needed. The position information of the devices 120 may be updated periodically or in a different manner.

In an alternate embodiment, aspects of the system 100 relevant to the identification may be incorporated into one or more devices 120. Thus, rather than the system 100 being a go-between between two users 210, each having one or more devices 120, one of the devices 120 of one of those users 210 may identify the other user 210 based on broadcast or polled information as well as on one or more databases 130 accessible by the devices 120.

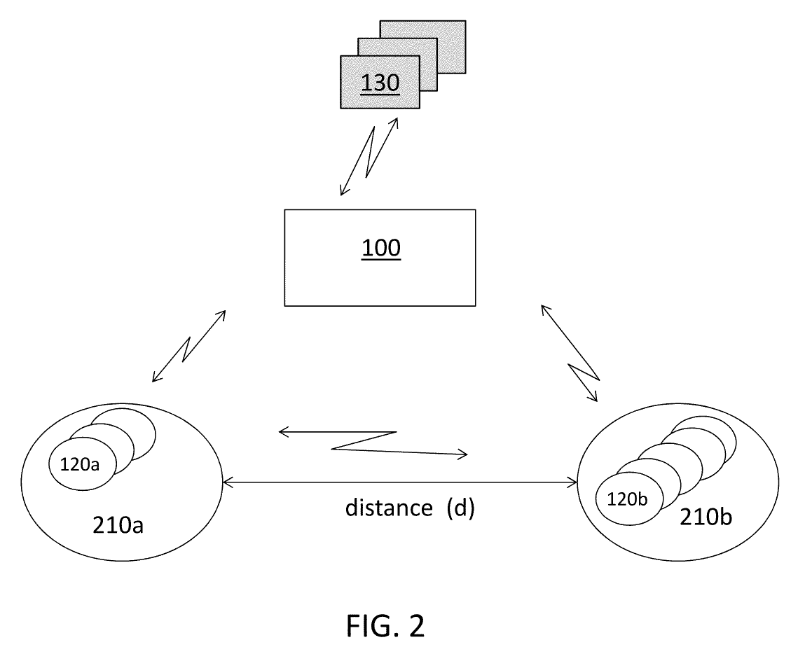

FIG. 2 illustrates an exemplary scenario with two users 210a and 210b (generally 210) of devices 120a and 120b (generally 120) in communication with the system 100 according to embodiments of the invention. As shown, the user 210a has three devices 120 (collectively referred to as 120a). The user 210b has five devices 120 (collectively referred to as 120b). The two users 210 are used to discuss different embodiments of the invention. The devices 120a and 120b may include cellular phones, tablets, glasses or contacts with heads-up displays, laptop computers, or any other computation or communication devices. According to one exemplary embodiment, one or more of the devices 120b of the user 210b may broadcast an identity (e.g., name) of the user 210b to the system 100. The broadcast of the user 210b identity may also be sent directly to one of more devices 120a of the user 210a. In this case, either by receiving the identity of the user 210b directly from a user 210b device 120b or indirectly—by receiving a broadcast or by polling and receiving a response—from the system 100, the user 210a learns the identity of the user 210b. In addition, the user 210a may be provided with a distance to the user 210b, as well. This distance is based on the system 100 determining a relative position of each of the devices 120a, 120b. Based on the devices 120a being carried by the user 210a, the user 210a may be provided this information as a heads up display on glasses or contact, as a message on a cellular device, or in some other way.

According to another exemplary embodiment, one or more devices 120a of the user 210a may broadcast or send, in response to polling from the system 100, information about the device 120a rather than an identify of the user 210a. That is, one or more devices 120a may send information that identifies the device 120a, for example. The information may be a WiFi identifier of a tablet device 120a, a network interface controller (NIC)/media access control (MAC) address of a Bluetooth device 120a, or some other information that uniquely or non-uniquely identifies the device 120a. In this case, if one or more of the devices 120a provides a unique device identifier, the system 100 may access one or more databases 130 to associate the identified device 120a with the user 210a and, thus, identify the user 210a. The database 130 may be an enterprise database 130 that includes an association between a company-provided device 120a (that provided its unique identification) and an identity of the user 210a of the device 120a, for example.

If one or more of the devices 120a provides a non-unique identifier, the system 100 may use a process of elimination to identify the user 210a or a set of people who could be the user 210a. For example, the number of devices 120a may be used to eliminate users 210 known by the system 100 to have fewer than the number of devices 120a. Information from databases 130 may be used in the process of elimination, as well. For example, if the users 210a and 210b are located within a cellular or enterprise area in the United States, and a calendar database 130 or email database 130 is available to the system 100, one or both of those databases 130 may be used to eliminate a user 210 as being the user 210a if that user 210 has a calendar entry or out-of-office message that indicates that the user 210 is in China. By using information from one or more databases 130, the system 100 narrows down possibilities for the identification of the user 210a. The process may continue for a predetermined period of time or may be limited in some other way, or the process may be continued until the set of possibilities for the user 210a is narrowed to a predetermined number. The process may include both inductive and deductive methods, direct, heuristics, or inference methods, or a combination thereof A combination of user 210a and device 120a (identification) information may be used in the process. The user 210b may be provided the identity (or possible identities) of the user 210a by one of the ways noted above (e.g., heads up display, laptop message) based on a broadcast or a response to an inquiry by the user 210b using one of the devices 120b.

As noted above, an identity of a user 210 may include a name or other unique identity or, alternately, a non-unique identity indicating a predetermined status (e.g., employee, authorized individual). The information from the user device 120 alone or in conjunction with one or more databases 130 may be used to identify the user 210. The identity of the user 210 may be an indication of whether the user belongs in or out of a predefined group. For example, employees may be gathered in a company cafeteria where their devices 120 are in communication with a system 100. Based on a user-selected preference or a position of a user 210b within the company or another predetermined factor, the system 100 may identify and provide a distance to a visitor (user 210a) within the cafeteria who has devices 120a that identify the user 210a as being a non-employee or an employee of a particular category (or, alternately, who does not have devices 120a that identify the user 210a as being an employee in a particular category such as cleared employees). With this information, the user 210b may ensure that no sensitive topics are discussed while the visitor (user 210a) is in the vicinity. Alternate to identifying one or more of the devices 120a as being those of a user 210a who is not in a particular group, a specific user 210a may be identified based on the embodiments discussed above, as well. That is, if user 210b is a manager who wishes to know when a particular employee user 210a is within a specified (e.g., hearing) range, the user 210b may select an alert option to be notified when user 210a has entered the specified range.

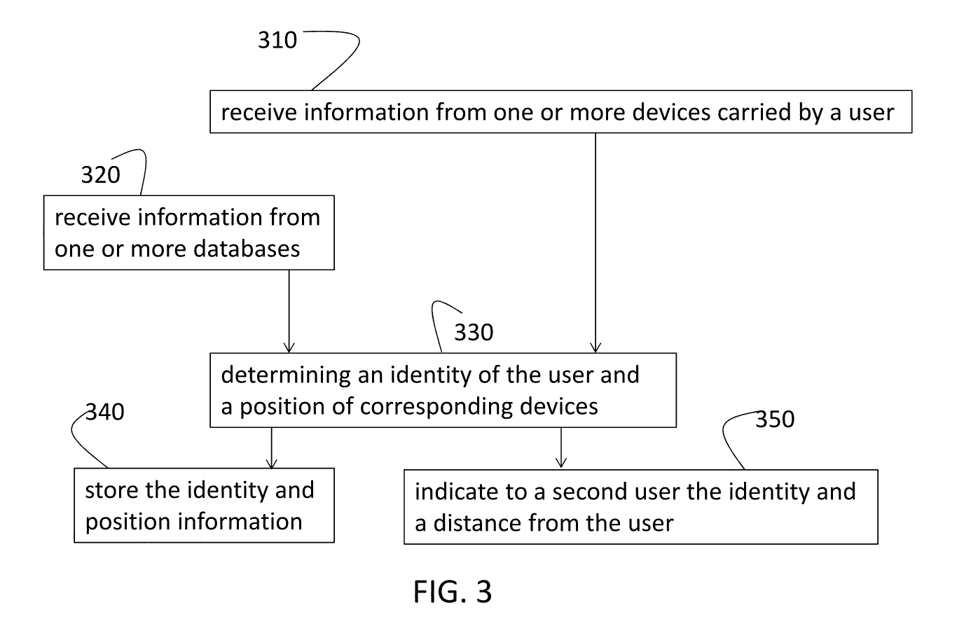

FIG. 3 is a process flow of a method of device-based identification according to embodiments of the invention. At block 310, receiving information from one or more devices 120a carried by a user 210a includes a system 100 polling the one or more devices 120a or some of the devices 120a broadcasting the information. The polling or broadcast may be based on the devices 120a being within a particular predefined zone of the system 100 or within a building or enterprise or cellular network, for example. At block 320, receiving information from one or more databases 130 is at the system 100 as needed. At block 330, determining an identity of the user 210a and a position of the corresponding devices 120a may be based directly on the information from the devices 120a or based additionally on information from one or more databases 130. The processor 110 of the system 100 may execute instructions to implement a process of elimination to identify the user 210a (by name or by a predefined category) using the information from the devices 120a and the databases 130. The system 100 may use triangulation or receive GPS information from one or more devices 120a, for example, to determine a position of the devices 120a (and, thus, the user 210a). At block 340, the method includes storing the identity and position information for the user 210a in the system 100. At block 350, indicating, to a second user 210b, the identity and a distance from the user 210a includes using the position information of devices 120a, 120b of both users 210a, 210b to determine the distance between them. The providing includes providing textual or verbal information to the user 210b on one of the user 210b devices 120b such as a heads up display on glasses or an alert on a cellular phone, for example. As noted above, the system 100 need not be separate from the devices 120 but may be part of a device 120b carried by the second user 210b in embodiments of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagram depicted herein is just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system to determine an identity of an individual carrying one or more devices configured to communicate with the system, the system comprising:
an input interface configured to receive information from one or more of the one or more devices;
a database configured to store data related to the individual in correspondence with the information; and
a processor configured to determine the identity of the individual based on the information when the information provides the identity directly and to determine the identity of the individual based on the data in the database when the information relates to the respective one or more of the one or more devices.

2. The system according to claim 1, wherein the input interface receives the information based on a broadcast or based on polling the one or more devices.

3. The system according to claim 1, wherein the identity of the individual is a name.

4. The system according to claim 1, wherein the identity of the individual is an indication of whether the individual is within or outside a specified group.

5. The system according to claim 1, wherein the processor is further configured to determine a position of the one or more of the one or more devices.

6. The system according to claim 5, further comprising an output interface indicating the identity and a distance to a second device of a second individual, wherein
when the system is part of the second device of the second individual, the indicating includes outputting the identity and the distance on the second device, and when the system is separate from the second device, the indicating includes transmitting the identity and the distance to the second device.

7. The system according to claim 6, wherein the distance is a distance between the one or more of the one or more devices of the individual and the device of the second individual.

8. The system according to claim 1, wherein the database stores, as the data, calendar entries or emails for the individual in correspondence with an identifier of the one or more of the one or more devices.

9. The system according to claim 1, wherein the database stores, as the data, a number of devices associated with the individual.

10. The system according to claim 1, wherein the input interface receives the information from the one or more of the one or more devices when the system detects that the one or more devices are within a predefined detection zone of the system.

11. A method of determining an identity of an individual carrying one or more devices configured to communicate with an identification system, the method comprising:
receiving, at an input interface of the identification system, information from one or more of the one or more devices;
storing, in a database, data related to the individual in correspondence with the information; and
processing, by a processor of the identification system, the information to identify the individual based directly on the information when the information provides the identity and based on the data from the database when the information relates to the respective one or more of the one or more devices.

12. The method according to claim 11, further comprising the one or more of the one or more devices broadcasting the information.

13. The method according to claim 11, further comprising the one or more of the one or more devices transmitting the information based on a polling by the identification system.

14. The method according to claim 11, wherein the identity is a name or an indication of whether the individual is within or outside a specified group.

15. The method according to claim 11, further comprising determining a distance between the individual and a second individual carrying a second device.

16. The method according to claim 15, further comprising indicating the identity and the distance with the second device by outputting the identity and the distance when the second device comprises the identification system.

17. The method according to claim 15, further comprising indicating the identity and the distance with the second device by transmitting the identity and the distance from the identification system to the second device when the identification system is separate from the second device.

18. The method according to claim 11, wherein the storing the data includes storing calendar entries or emails for the individual in correspondence with an identifier of the one or more of the one or more devices.

19. The method according to claim 11, wherein the storing the data includes storing a number of devices associated with the individual.

20. The method according to claim 11, further comprising detecting that the one or more devices are within a predefined detection zone of the identification system.
